(19) United States
(12) Patent Application Publication
(10) Pub. No.: US 2018/0337773 A1
(43) Pub. Date: Nov. 22, 2018

(54) COMMUNICATION DEVICE AND COMMUNICATION METHOD

(71) Applicant: FUJITSU LIMITED, Kawasaki-shi (JP)

(72) Inventors: Dai SUZUKI, Kawasaki (JP); SATOSHI IMAI, Kawasaki (JP)

(21) Appl. No.: 15/970,922

(22) Filed: May 4, 2018

(30) Foreign Application Priority Data
May 19, 2017 (JP) 2017-100126

(51) Int. Cl. H04L 9/08; H04L 9/14

(52) U.S. Cl. CPC H04L 9/0819; H04L 9/14

(57) ABSTRACT

A communication device including a memory, and a processor coupled to the memory and the processor configured to determine a transmission order such that at least one of a maximum value of a common key generation time from among two or more communication devices and a number of times of key generation processing by the two or more communication devices becomes a minimum value, instruct another communication device from among the two or more communication devices to transmit a partial key in accordance with the transmission order determined, and transmit a partial key generated, in accordance with the determined transmission order.

### CROSS-REFERENCE TO RELATED APPLICATION

This application is based upon and claims the benefit of priority of the prior Japanese Patent Application No. 2017-100126, filed on May 19, 2017, the entire contents of which are incorporated herein by reference.

### FIELD

The embodiments discussed herein are related to a communication device and a communication method.

### BACKGROUND

Recently, two or more companies, operators, and the like (hereinafter collectively referred to as companies) share data including participant's confidential information to cooperate with each other. For such data sharing between the companies, there is a case in which the data is transmitted through a transmission path such as the Internet (hereinafter also referred to as a network). In such data transmission, data may be encrypted and transmitted in order to avoid eavesdropping. Keys are used for such data encryption and decoding, but it is desirable that parties hold such keys, and therefore, the keys may be transmitted and received between the parties. However, eavesdropping of information on the keys during delivery through a network is a problem. As a method to solve such a problem of the key delivery, there is a public key cryptography in which different keys are respectively used for encryption (public key) and decoding (private key). However, in a communication using the public key cryptography, there is a case in which a different key is to be prepared for each of the parties or a case in which encryption is to be performed by the number of times corresponding to the number of keys for the same data, and therefore, the public key cryptography may become inefficient in this case.

In addition, recently, from the viewpoint of promptness and efficiency of business, there is a case in which a mechanism is desired that enables information to be shared between two or more companies quickly and safely. In addition, as a key sharing method used in such a case, for example, a Diffie-Hellman key sharing method (hereinafter also referred to as a DH key sharing method) is used. In the DH key sharing method, each node holds a private key and transmits a partial key generated from the private key to another node in the same group. Each of the nodes in the group generates a common key from a private key stored in the node and a received partial key. In addition, each of the nodes in the group performs transmission and reception of data by using such a common key. Here, typically, it is difficult to guess a private key from a received partial key. Therefore, in the key transmission of the DH key sharing method, information is difficult to leak even when the partial key is eavesdropped, and therefore, high security strength may be expected for the information.

Japanese Laid-open Patent Publication No. 2004-248270 is the related art.

### SUMMARY

According to an aspect of the invention, a communication device includes a memory, and a processor coupled to the memory and the processor configured to determine a transmission order such that at least one of a maximum value of a common key generation time from among two or more communication devices and a number of times of key generation processing by the two or more communication devices becomes a minimum value, instruct another communication device from among the two or more communication devices to transmit a partial key in accordance with the transmission order determined, and transmit a partial key generated, in accordance with the determined transmission order.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a schematic configuration of a communication system according to an embodiment;

FIG. 2 is a diagram illustrating an example of generation processing of common keys by a DH key sharing method;

FIG. 3 is a functional block diagram illustrating a communication device according to the embodiment;

FIG. 4 is a schematic diagram illustrating common key generation times;

FIG. 5 is a schematic diagram illustrating the number of times of key generation processing;

FIG. 6 is a diagram illustrating an example of a hardware configuration of the communication device according to the embodiment;

FIG. 7 is a diagram illustrating an example of transmission order of the group, which is represented as a permutation;

FIG. 8 is a flowchart illustrating search processing of transmission order by the communication device according to the embodiment;

FIG. 9 is a diagram illustrating an example of crossover in the embodiment;

FIG. 10 is a diagram illustrating an example of mutation in the embodiment;

FIG. 11 is a diagram illustrating an example of transmission order determined by the communication device according to the embodiment; and

FIG. 12 is a diagram illustrating a comparative example of an effect by a communication method according to the embodiment and an effect by a communication method in the related art.

### DESCRIPTION OF EMBODIMENTS

Until each of the nodes in the group generates a common key by using the DH key sharing method, processing to generate and transmit a partial key may be executed two or more times, and a load of the processing may not be small. In addition, a time taken to transmit a partial key from a node to another node (hereinafter also referred to as a transmission time) may cause delay of a time taken to complete generation of a common key. In addition, the common key may be frequently updated from the viewpoint of safety because eavesdropping of data in a transmission path may occur due to leakage of information related to the common key.

In the DH key sharing method of the related art, an order of nodes to each of which a corresponding partial key is transmitted may not be optimized, and therefore, a case has sometimes occurred in which a reduction in the number of times of generation processing of a partial key or a reduction in a time taken to generate a common key in the node is not achieved.

Embodiments of a technology by which the efficiency of generation processing of a common key is improved are described below with reference to the drawings.

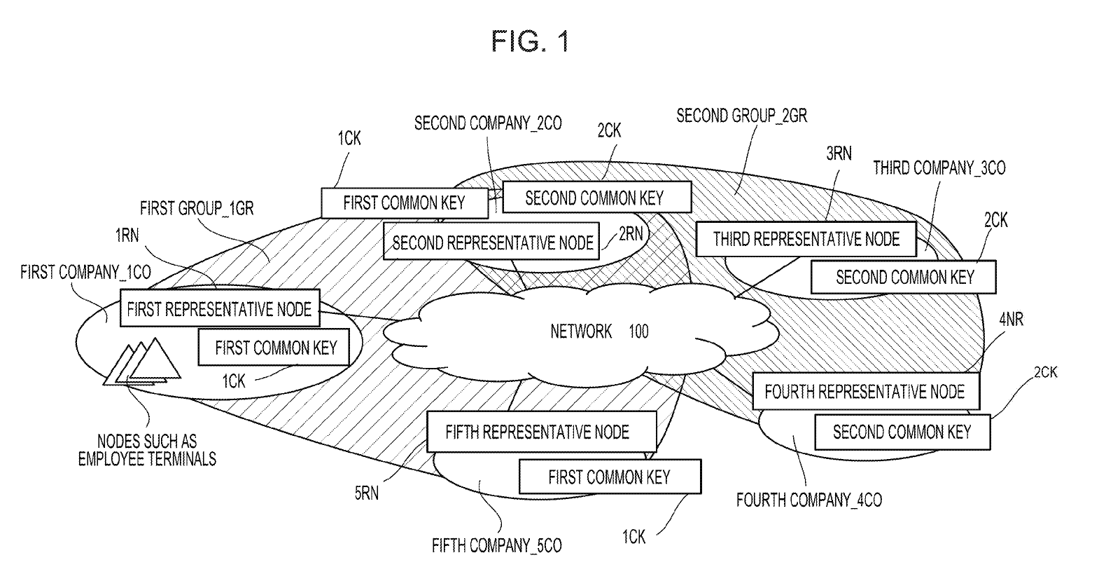

FIG. 1 is a diagram illustrating a schematic configuration of a communication system according to an embodiment. In the embodiment, in order to share information between two or more companies in a group safely, one or more representative nodes of each of the companies (hereinafter referred to as representative nodes) generate a common key shared in the group. A detail of the communication system is described below.

In FIG. 1, a first group_1GR including a first company_1CO, a second company_2CO₃ and a fifth company_5CO and a second group_2GR including the second company_2CO₃ a third company_3CO₃ and a fourth company_4CO are illustrated. As illustrated in FIG. 1, the companies are coupled through a network 100 so as to communicate with each other. The companies in the first group_1GR transmit and receive information privately to and from companies that do not belong to the first group_1GR. Similarly, the companies in the second group_2GR transmit and receive information privately to and from companies that do not belong to the second group_2GR. In order to conceal information transmitted and received to and from each other in the group against others outside of the group, the information is encrypted by a common key in the group. Each of the nodes in the same group encrypts information to be transmitted and decodes received information by using the common key in the group to transmit and receive the information to and from the other companies in the group. The common key in each of the groups is generated by one or more representative nodes of each of the companies in the group. In the embodiment, it is assumed that a single representative node is applied to each of the companies. However, the embodiment is not limited to such an example. In FIG. 1, the common key in the first group_1GR is referred to as a first common key_1CK, and each of the representative nodes of the first company_1CO, second company_2CO₃ and fifth company_5CO generates the first common key_1CK, and each node in the companies encrypts and decodes information by using the first common key_1CK to perform transmission and reception of the information. Similarly, the common key in the second group_2GR is referred to as a second common key_2CK, and each of the representative nodes of the second company_2CO₃ third company_3CO₃ and fourth company_4CO generates the second common key_2CK, and each node in these companies encrypts and decodes information by using the second common key_2CK to perform transmission and reception of the information. Each node other than the representative node in each of the companies obtains the common key that has been generated by the representative node through an internal network such as an intranet. A description of the nodes other than the representative nodes in the group is omitted herein.

In the embodiment, it is assumed that the DH key sharing method is used in order to share a common key between representative nodes of respective two or more companies in the same group. In addition, the common key may be updated in the group for safe delivery of information on the common key by considering leakage of the information through a user in the same group. The DH key sharing method is described below.

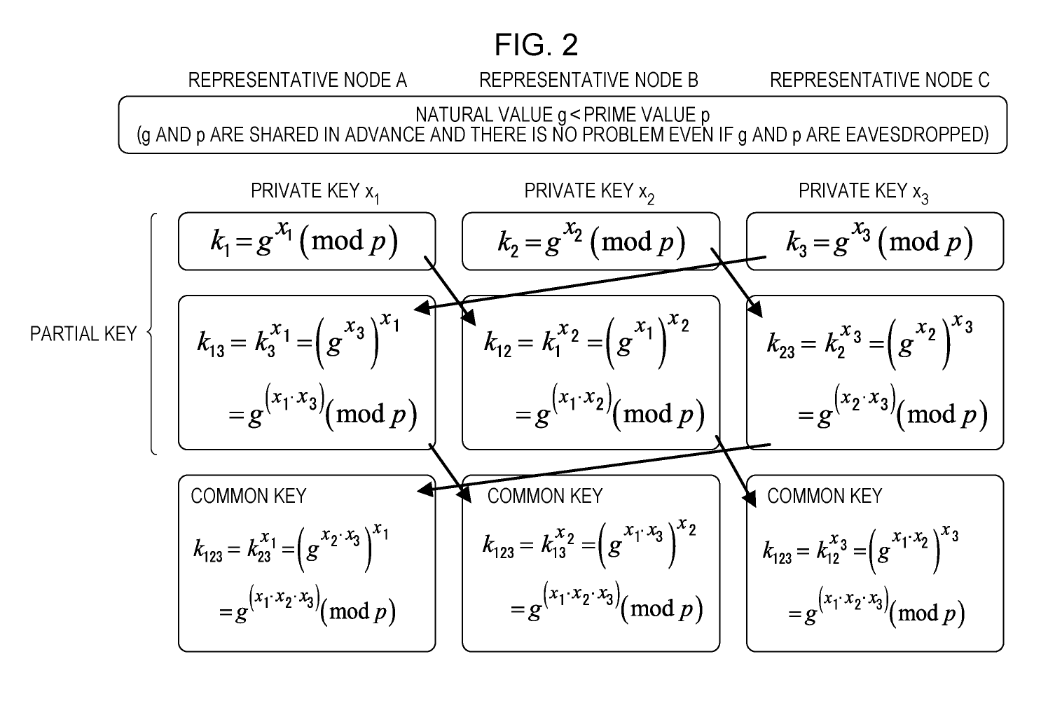

FIG. 2 is a diagram illustrating an example of generation processing of common keys by the DH key sharing method. Generation processing of common keys by three representative nodes A, B, and C is described below. The representative nodes A, B, and C share a natural number g and a prime number p. Here, the prime number p is larger than the natural number g. There is no problem even when the values of the prime number p and the natural number g are eavesdropped or the like, and therefore, the values may be shared through the network. Each of the representative nodes A, B, and C generates a private key. Here, it is assumed that a private key of the representative node A is x₁, a private key of the representative node B is x₂, and a private key of the representative node C is x₃. Each of the representative nodes generates a partial key by using the natural number g, the prime number p, and the private key. For example, when partial keys generated by the representative nodes A, B, and C are referred to as k₁, k₂, and k₃, respectively, the partial keys k₁, k₂, and k₃ are generated, for example, in accordance with the following equations (1) to (3), respectively.

k₁=g^{x}^{₁}(mod p) (1)

k₂=g^{x}^{₂}(mod p) (2)

k₃=g^{x}^{₃}(mod p) (3)

A representative node transmits the generated partial key to another representative node in the same group. The representative node that has received the partial key generates a new partial key by combining the received partial key and information on the private key of the representative node (such generation of a new partial key is also referred to as conversion of a partial key). In addition, such a new partial key is further transmitted from the representative node to another representative node in the same group. The order of the representative nodes to each of which a corresponding partial key is transmitted so as to be generated from a private key and then converted into a new partial key as described above is also referred to as transmission order. Such transmission order is determined before each of the representative nodes transmits a partial key to another representative node, and each of the representative nodes transmits the partial key in accordance with such transmission order. In the transmission order in FIG. 2, it is assumed that the representative node B receives a partial key that has been transmitted from the representative node A, the representative node C receives a partial key that has been transmitted from the representative node B, and the representative node A receives a partial key that has been transmitted from the representative node C. Thus, the representative node A transmits a partial key “k₁.” to the representative node B, the representative node B transmits a partial key “k₂” to the representative node C, and the representative node C transmits a partial key “k₃” to the representative node A.

Each of the representative nodes, which has received a partial key, generates a new partial key by combining the received partial key and a private key of the representative node. For example, the representative node A generates a new partial key k₁₃ by combining the received partial key “k₃” that has been received from the representative node C and the private key x₁ of the representative node A. Similarly, the representative node B generates a new partial key k₁₂ by combining the received partial key “k₁.” and the private key x₂ of the representative node B and the representative node C generates a new partial key k₂₃ by combining the received partial key “k₂” and the private key x₃ of the representative node C. The partial keys k₁₂, k₂₃, and k₁₃ respectively satisfy, for example, the following equations (4) to (6).

$$\begin{matrix}\begin{matrix}{k}_{12} = {k}_{1}^{{x}_{2}} = {( {g}^{{x}_{1}} )}^{{x}_{2}} \\ = {g}^{( {x}_{1} \cdot {x}_{2} )} ( mod p )\end{matrix} & ( 4 ) \\ \begin{matrix}{k}_{23} = {k}_{2}^{{x}_{3}} = {( {g}^{{x}_{2}} )}^{{x}_{3}} \\ = {g}^{( {x}_{2} \cdot {x}_{3} )} ( mod p )\end{matrix} & ( 5 ) \\ \begin{matrix}{k}_{13} = {k}_{3}^{{x}_{1}} = {( {g}^{{x}_{3}} )}^{{x}_{1}} \\ = {g}^{( {x}_{1} \cdot {x}_{3} )} ( mod p )\end{matrix} & ( 6 )\end{matrix}$$

Here, k₁₂, k₂₃, and k₁₃ are transmitted from the representative nodes B, C, and A to the representative nodes C, A, and B, respectively.

In FIG. 2, the partial key that each of the representative nodes receives is a partial key with which a private key of a representative node other than the representative node that had received the partial key has been combined. For example, the partial key k₂₃ that the representative node A has received is a partial key with which the private keys of the representative nodes B and C have been combined. When the private key of the representative node A is combined with such a partial key, a key k₁₂₃ with which the private keys of the representative nodes A, B, and C have been combined is eventually generated. Similarly, a key k₁₂₃ is generated for each of the representative nodes B and C. Such a key k₁₂₃ is represented, for example, by the following equation (7).

$$\begin{matrix}{k}_{123} = {k}_{12}^{{x}_{3}} = {( {g}^{{x}_{1} \cdot {x}_{2}} )}^{{x}_{3}} \\ = {g}^{( {x}_{1} \cdot {x}_{2} \cdot {x}_{3} )} ( mod p )\end{matrix} \qquad ( 7 )$$

The key k₁₂₃ becomes the same value regardless of the combination order of the private keys. Thus, the value of the key k₁₂₃ may be used as a common key in a communication between the representative nodes A, B, and C.

Here, transmission order of partial keys is described below. The last representative node in certain transmission order generates a common key. The last representative nodes of two or more pieces of transmission order are different. This is why the representative nodes redundantly obtain partial keys, and excess transmission is performed when the last representative nodes are the same in the two or more pieces of transmission order. In addition, there are pieces of transmission order in which respective representative nodes each of which generates a common key are set as the last representative node. If a representative node that is to generate a common key is not the last node in transmission order, the representative node does not generate a common key, and therefore, encryption of information is not performed. Therefore, there exists a single piece of transmission order for each representative node that generates a common key. Therefore, a certain single piece of transmission order is also referred to as transmission order of a representative node that becomes the last representative node in the transmission order. In addition, pieces of transmission order of all of the representative nodes in the group are also referred to as transmission order of the group.

In the embodiment, it is assumed that the above-described DH key sharing method is used. However, a method using an elliptic curve (elliptic curve DH key sharing method) or the like, may be used instead of the DH key sharing method.

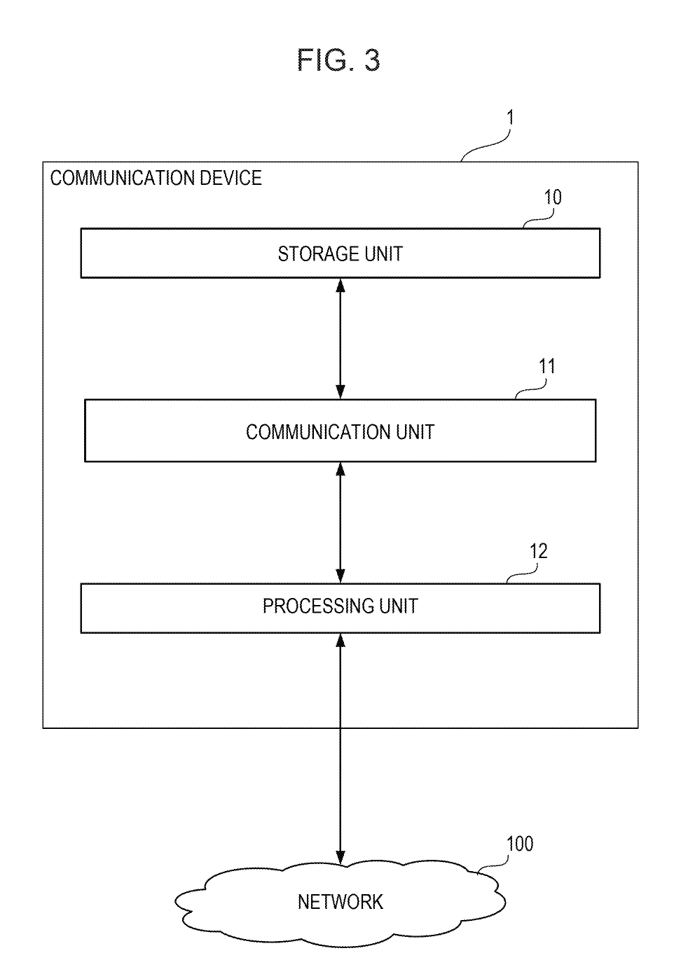

FIG. 3 is a functional block diagram illustrating a communication device 1 corresponding to a representative node according to the embodiment. The communication device 1 includes a storage unit 10, a communication unit 11, and a processing unit 12. The processing unit 12 is coupled to the storage unit 10 and the communication unit 11. The storage unit 10 may be coupled to the communication unit 11.

The storage unit 10 stores various types of information used for processing by the processing unit 12. Such information includes numbers respectively applied to communication devices 1 described later. In addition, the storage unit 10 may store a transmission order that has been determined by the processing unit 12. In addition, the storage unit 10 may store a private key, the above-described values of the prime number p and the natural number g, and the like.

The communication unit 11 transmits and receives data to and from other nodes and the like through a network 100. In addition, the communication unit 11 receives a partial key from another communication device 1 and outputs the received partial key to the processing unit 12, and transmits a partial key that has been generated by the processing unit 12 to another communication device 1 through the network 100. In addition, the communication unit 11 transmits the partial key to the other communication device 1 in accordance with an instruction from the processing unit 12. Due to such transmission of the partial key, the communication unit 11 may apply, to the partial key generated by the processing unit 12, information on another communication device 1 the private key of which is used to generate the partial key by the processing unit 12.

The processing unit 12 generates a partial key or a common key by using the private key of the communication device 1 and a received partial key. The processing unit 12 may store the private key, the values of the prime number p and the natural number g, and the like, instead of the storage unit 10 or with the storage unit 10. In addition, the processing unit 12 determines transmission order of partial keys. The processing unit 12 outputs the generated partial key to the communication unit 11 instructs the communication unit 11 to transmit the partial key in accordance with the determined transmission order. The processing unit 12 may read the transmission order stored in the storage unit 10 and instruct the communication unit 11 to transmit the partial key in accordance with the transmission order.

In the embodiment, when a certain communication device 1 in the group has determined a transmission order, the certain communication device transmits the transmission order to other communication devices 1 in the same group. The certain communication device 1 that has determined the transmission order may transmit the transmission order to the other communication devices 1 in the same group at the same time. Alternatively, the certain communication device 1 that has determined the transmission order transmits the transmission order to some of the other communication devices 1 in the same group. In this case, the transmission order is further transmitted from the communication device 1 that has received the transmission order to another communication device 1 in the same group, and all of the communication devices 1 in the same group eventually obtain the transmission order.

In addition, in the embodiment, it is assumed that transmission order is determined by a certain single communication device 1 in the group. In this case, a communication device 1 that determines the transmission order may be different each time a common key is updated or may be consistently the same.

Instead of the above-described case, the transmission order may be determined by a higher-level device coupled to the communication devices 1 in the group, and the higher-level device may notify each of the communication devices 1 of the determined transmission order. In addition, alternatively, the transmission order may be determined by two or more communication devices 1 in the group, and in this case, a different method to maintain consistency may be executed.

The processing unit 12 of the communication device 1 that has received the transmission order from another communication device 1 (or the higher-level device) stores the transmission order and may instruct the communication unit 11 to transmit a partial key in accordance with the transmission order. Alternatively, in the communication device 1 that has received the transmission order, the storage unit 10 stores the transmission order, and the processing unit 12 may read the transmission order from the storage unit 10 and instruct the communication unit 11 to transmit the partial key in accordance with the transmission order.

The processing unit 12 stores the following equation (8) to determine transmission order. Such an equation (8) may be stored in the storage unit 10, and the processing unit 12 may read the equation (8) from the storage unit 10 as appropriate.

p·worst(T₁,T₂, . . . ,Tₙ)+q·i (8)

In the equation (8), “n” represents the total number of communication devices 1 that are representative nodes in the group. As described above, a different number is applied to each of the communication devices 1 in the group, and the communication device 1 stores a number of the communication device and numbers of the other communication devices 1. Here, “Tₘ” (m is a natural number from 1 to n) represents a common key generation time of the m-th communication device 1 from among the n communication devices 1. Such a common key generation time Tₘ is defined as follows. In transmission order in which the m-th communication device 1 becomes the last communication device 1, a time at which the first communication device 1 in such transmission order generates a partial key from a private key of the first communication device 1 is set as a starting point, and a time at which the m-th communication device 1 generates a common key is set as an ending point. A common key generation time of the m-th communication device 1 is obtained by subtracting times for pieces of processing by the communication devices 1 in the transmission order from a time period from the starting point to the ending point. That is, “Tₘ” is a total time taken to transmit partial keys that are sources of a common key generated by the m-th communication device 1.

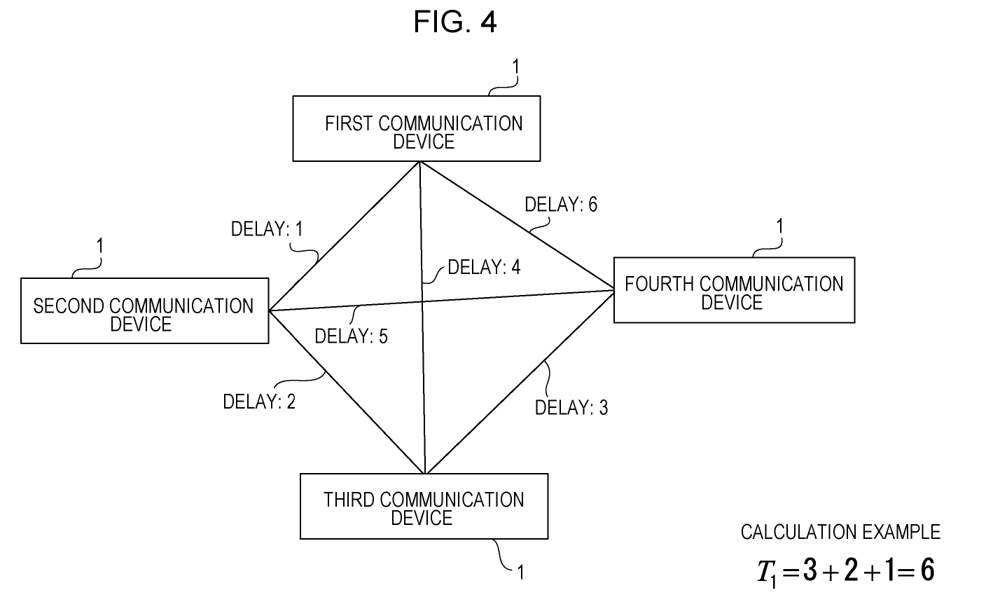

FIG. 4 is a schematic diagram illustrating common key generation times. Here, a case is described in which four communication devices 1 exist in a group. The communication devices 1 are coupled through a network so as to communicate with each other. Here, in FIG. 4, a line that connects two communication devices 1 indicates a transmission path that connects the two communication devices 1. In addition, it is assumed that “x” in “delay: x” in the line indicating the transmission path represents a transmission time of a partial key in the transmission path. Here, “x” may be a proportion of the transmission time of the partial key in the transmission path for transmission times of partial keys in the other transmission paths. Each of the communication devices 1 obtains such a transmission time of the partial key in the transmission path in advance. In the example illustrated in FIG. 4, it is assumed that one second is taken to transmit a partial key between the first communication device 1 and the second communication device 1, and six seconds are taken to transmit a partial key between the first communication device 1 and the fourth communication device 1. However, a unit of time is not limited to “a second” or the like and may be set arbitrarily.

Here, a common key generation time in the first communication device 1 is described with reference to FIG. 4. It is assumed that the transmission order of partial keys, which is used to generate a common key in the first communication device 1 (transmission order of the first communication device 1), corresponds to the order of the fourth communication device 1, the third communication device, the second communication device 1, and to the first communication device 1. In FIG. 4, a transmission time taken until the third communication device 1 receives a partial key generated by the fourth communication device 1 after the fourth communication device 1 has transmitted the partial key to the third communication device through the transmission path is three seconds. Similarly, a transmission time of a partial key from the third communication device 1 to the second communication device 1 is two seconds, and a transmission time of a partial key from the second communication device 1 to the first communication device 1 is one second. Therefore, “T₁=3+2+1=6 seconds” is obtained.

Returning to the explanation of the equation (8), the function “worst” is used to select the maximum common key generation time from among T₁ to Tₙ. For example, when “Tₖ” (k is a natural number that is 1 or more or n or less) becomes the maximum value from among the common key generation times T₁ to Tₙ, “worst (T₁, T₂, . . . , Tₙ)=Tₖ” is obtained. A value obtained by the function worst (T₁, T₂, . . . , Tₙ) is also referred to a worst value.

Here, “i” in the second term of the equation (8) represents the total number of times of key generation processing. The number of times of key generation processing is the total number of times of generation processing of partial keys and common keys by all of the communication devices 1 in the group. The number of times of key generation processing is described below in detail.

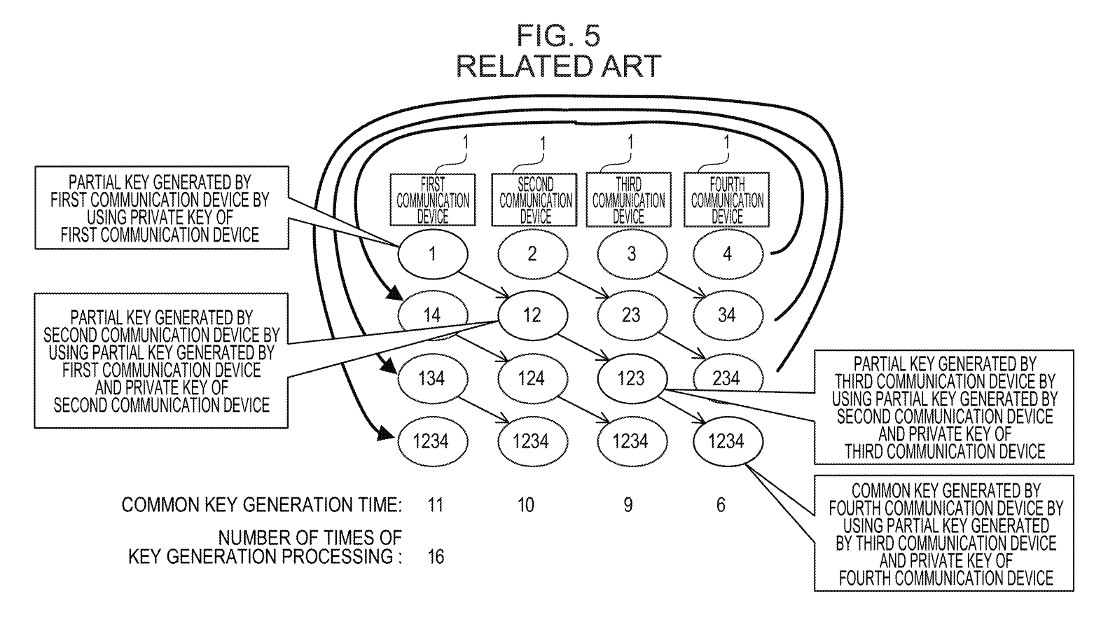

FIG. 5 is a schematic diagram illustrating the number of times of key generation processing. Here, it is assumed that a route corresponding to transmission order of partial keys on the transmission path is a circular permutation route in the related art. Hereinafter, the route in the transmission path, which corresponds to the transmission order, is also referred to as a transmission route.

First, the circular permutation route is described. The circular permutation route corresponds to transmission order determined by a communication device in the related art, but the communication device according to the embodiment 1 may determine transmission order corresponding to the circular permutation route. In FIG. 5, a transmission route of partial keys by using the first communication device 1 as a starting point is a combination of a transmission route from the first communication device 1 to the second communication device 1, a transmission route from the second communication device 1 to the third communication device, and a transmission route from the third communication device to the fourth communication device 1. Such a transmission route or transmission order is abbreviated as “1→2→3→4”. Similarly, a transmission route or transmission order of partial keys by using the second communication device 1 as a starting point is abbreviated as “2→3→4→1”, a transmission route or transmission order of partial keys by using the third communication device 1 as a starting point is abbreviated as “3→4→1→2”, and a transmission route or transmission order of partial keys by using the fourth communication device 1 as a starting point is abbreviated as “4→1→2→3”. The order of the communication devices 1 is defined in each of the pieces of the transmission order corresponding to the circular permutation route, and such transmission order is circulated. Such a transmission route corresponding to the circular permutation route is determined by solving a traveling salesman problem in the related art.

In FIG. 5, pieces of processing executed by the communication devices 1 when partial keys are transmitted through the transmission route of “1→2→3→4” are described below. First, the first communication device 1 generates a partial key by using a private key of the first communication device 1. Such a partial key is referred to as “1”. The partial key “1” is transmitted to the second communication device 1, and the second communication device 1 generates a partial key by using the partial key “1” and a private key of the second communication device 1. The partial key generated at that time is referred to as “12”. In the following description, it is assumed that the partial key generated by the communication device 1 is represented by combining a numeric value associated with a number that has been applied to the communication device 1 and a numeric value indicating a partial key received at the communication device 1. In addition, it is assumed that a similar combination method is also applied to a common key generated by the communication device 1 that is an ending point in the transmission of partial keys.

In the transmission route of “1→2→3→4”, the partial key “12” that have been generated by the second communication device 1 is transmitted to the third communication device, and the third communication device generates a partial key “123” by using the partial key “12” and a private key of the third communication device. The partial key “123” is transmitted to the fourth communication device, and the fourth communication device 1 generates a common key “1234” by using the partial key “123” and a private key of the fourth communication device 1. Similarly, the first communication device 1, the second communication device 1, and the third communication device generate common keys “1234” as the ending points of the transmission routes such as “2→3→4→1”, “3→4→1→2”, and “4→1→2→3”, respectively.

The number of times of key generation processing is described below with reference to FIG. 5. As seen in FIG. 5, each of the communication devices 1 generates a key such as a partial key or a common key four times in total. For example, the first communication device 1 generates the partial key “1” and generates a partial key “14” by using a partial key that has been received from the fourth communication device 1, and similarly, the first communication device 1 generates a partial key “134” and a common key “1234”. The total number of times of generation processing of keys by the first to fourth communication devices 1 in the group becomes “4×4=16”. As described above, the number of times of key generation processing is the total number of times of generation processing of keys by the communication devices 1 in the group, such that “16” equal to the number of ellipses in each of which a numeric value indicating a key is written is the number of times of key generation processing in the case of FIG. 5.

Returning to the explanation of the equation (8), “p” and “q” are respectively weighting factors of a worst value and the number of times of key generation processing. Here, the weighting factor p has a different definition from that of the prime number p in the equations (1) to (7) described with reference to FIG. 2. It is assumed that the weighting factors p and q are respectively set as numeric values used to adjust the value of the worst (T₁, T₂, . . . , Tₙ) and “i” as appropriate. For example, the weighting factors p and q are values used to match the number of digits of numeric values of the terms in the equation (8) with each other. For example, when the value obtained by the worst (T₁, T₂, . . . , Tₙ) of the first term corresponds to order of 10⁻³ and the value of “i” of the second term corresponds to order of 10⁰, the weighting factors p and q become, for example, values used to adjust the orders such as 1000 and 1, or the like. The weighting factors p and q may be set, for example, by using a proportion of an average of common key generation times and the number of times of key generation processing.

The value obtained by the equation (8) is a value that is an evaluation index used to determine transmission order by the communication device 1, and the value is also referred to as an evaluation value. Information on a processing time in each of the communication devices 1 such as a time taken to generate a key after the communication device 1 has received a partial key is omitted in the equation (8). This is why such information may be changed depending on an operation status or the like of the communication device 1 for each piece of generation processing of a key. However, a value obtained by combining such information and the equation (8) may be used as an evaluation index for determination of transmission order. For example, the communication device 1 that determines the transmission order may hold information on time schedules and the like of the communication devices 1 in the group and determine an amount of a used resource in each of the communication devices 1, a time at which the resource is used, and the like. Such information on the time schedule and the like may be transmitted from each of the communication devices 1 in the group to the communication device 1 that determines the transmission order. The communication device 1 that determines the transmission order may estimate a time taken for generation processing of a key in each of the communication devices 1 by using such information. In addition, the communication device 1 that determines the transmission order may use the estimated time taken to execute generation processing of a key for obtaining of a value of an evaluation index.

The processing unit 12 of the communication device 1 determines transmission order of the group such that the above-described value of the evaluation index becomes smaller. For example, the communication device 1 may determine a transmission order of the group such that the evaluation value becomes smaller or the value of at least one of the first term and the second term of the equation (8) becomes smaller. In the latter case, the communication device 1 may determine the transmission order of the group such that the value of at least one of the first term and the second term of the equation (8) becomes a minimum value. It is assumed that the communication device 1 according to the embodiment determines transmission order such that the evaluation value becomes a minimum value. Such determination is performed by search processing of a transmission order of the group. Such search processing is described later.

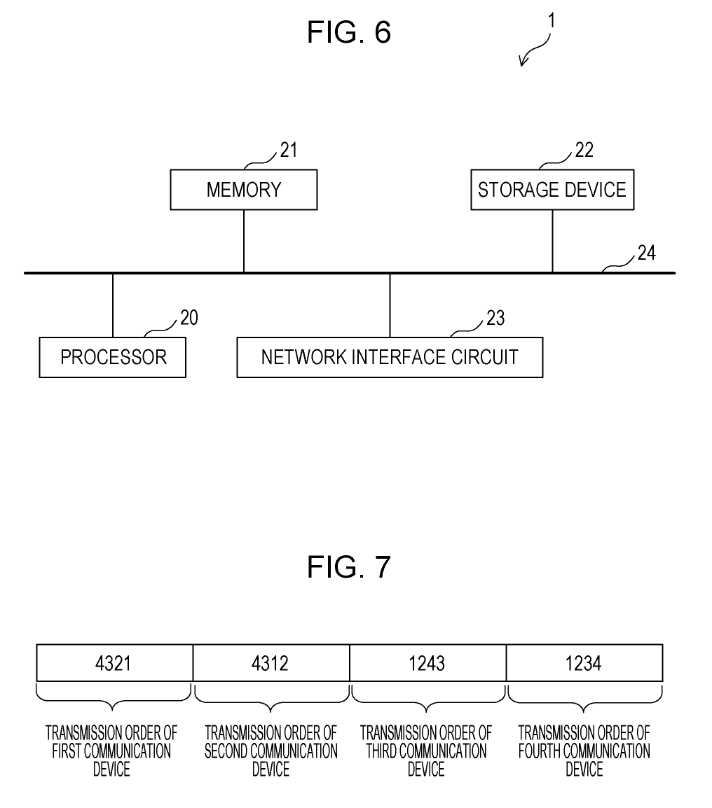

FIG. 6 is a diagram illustrating an example of a hardware configuration of the communication device 1 according to the embodiment. Here, the communication device 1 includes hardware as a typical computer, and processing by the communication device 1 is executed such that the following hardware may be used. The communication device 1 includes a processor 20, a memory 21, a storage device 22, and a network interface circuit 23 that are coupled to each other through a bus 24.

The processor 20 is, for example, a single-core processor, a dual-core processor, or a multi-core processor.

The memory 21 is, for example, a read only memory (ROM), a random access memory (RAM), or a semiconductor memory.

When the processor 20 executes various programs stored in the memory 21 by using information stored in the memory 21 or information that has been read from the storage device 22 into the memory 21, functions of the processing unit 12 (illustrated in FIG. 3) may be realized.

The storage device 22 is, for example, a hard disk drive, an optical disk device, or the like, or may be an external storage device or a portable storage medium. A function of the storage unit 10 may be realized by the storage device 22.

The network interface circuit 23 is an interface used when the communication device 1 communicates with another communication device 1 or another node through a local area network (LAN), the Internet, an intranet, or the like. A function of the communication unit 11 may be realized by the network interface circuit 23.

Instead of the above-described example, all or some of the functions of the functional block illustrated in FIG. 3 may also be realized by dedicated hardware as appropriate.

A specific example of the above-described determination method of transmission order in which an evaluation index becomes a minimum value is described below. The above-described transmission order of the communication device 1 or transmission order of the group may be represented as a sequence (permutation). Such a permutation is, for example, an array in which numbers that have been respectively applied to the communication devices 1 are arranged in accordance with the transmission order. FIG. 7 is a diagram illustrating an example transmission order of the group, which is represented as a permutation. The permutation in the FIG. 7 corresponds to a transmission order of the group when the first to fourth communication devices 1 exist in the group. With reference to FIG. 7, permutations of pieces of transmission order of the first to fourth communication devices 1 are respectively “4321”, “4312”, “1243”, and “1234”. Therefore, the pieces of transmission order of the first to fourth communication devices 1 are respectively “4→3→2→1”, “4→3→1→2”, “1→2→4→3”, and “1→2→3→4”. In addition, in FIG. 7, a permutation of transmission order of the group is “4321431212431234”.

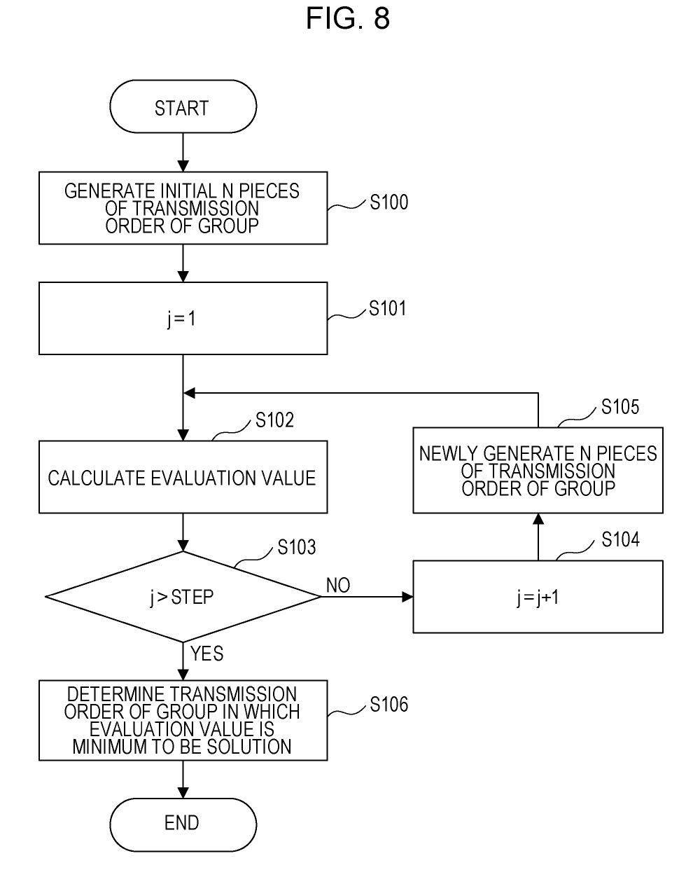

FIG. 8 is a flowchart illustrating search processing of a transmission order by the communication device 1 according to the embodiment. A search method of the transmission order of the group, in which an evaluation value becomes a minimum value by the communication device 1, is described below with reference to FIG. 8.

In Operation S100 of FIG. 8, the processing unit 12 of the communication device 1 (illustrated in FIG. 3) generates N permutations each corresponding to a transmission order of the group (Operation S100). At that time, the permutations are generated randomly in accordance with the conditions described in the following conditions (1) and (2) or by using another search method having a short calculation time. Here, as a permutation generated by using the other search method, for example, there is a circular permutation obtained by “search” using a known greedy algorithm. Here, “N” is a natural number determined by the user in advance. Hereinafter, “permutation corresponding to transmission order of the group” is also referred to as “transmission order of the group”. Similarly, “permutation corresponding to transmission order of the m-th communication device 1” is also referred to as “transmission order of the m-th communication device 1”.

The communication device 1 generates a transmission order of the group such that the following conditions (1) and (2) are satisfied:

(1) The last number of the transmission order of a communication device 1 in transmission order of the group corresponds to a number of the communication device 1; and

(2) In the transmission order of the communication devices 1, numeric values corresponding to respective numbers of all of the communication devices 1 in the group are included.

The reason why (1) is to be satisfied is based on that transmission order of the m-th communication device 1 is a transmission order when the m-th communication device 1 generates a common key, and therefore, the last communication device 1 in the transmission order is the m-th communication device 1. Therefore, “search” of the transmission order is performed such that numbers other than the last number in the transmission order of the communication devices 1 are rearranged.

In addition, the reason why (2) is to be satisfied is based on that, in the DH key sharing method, a certain communication device 1 is to use private keys of all of the communication devices 1 to generate a common key.

With reference to FIG. 7, the pieces of the transmission order of the first to fourth communication devices 1 satisfy conditions (1) and (2). For example, in FIG. 7, the transmission order of the first communication device 1 is “4321”, and the last number is “1”, which is the same as the number of the first communication device 1, such that condition (1) is satisfied. In addition, in such transmission order of the first communication device 1 in FIG. 7, numeric values corresponding to numbers of the respective four communication devices 1 are included, such that condition (2) is satisfied.

Returning to FIG. 8, the processing unit 12 of the communication device 1 prepares “j” storing a count value, which is used to count the number of times of calculation processing for evaluation values of the respective N pieces transmission order in the group in the following Operation S102. The processing unit 12 stores “1” in “j” by setting processing to calculate evaluation values of the respective N pieces of transmission order in the group, which have been generated in Operation S100, as the first calculation processing of the evaluation values (Operation S101). Hereinafter, y pieces of transmission order of the group are also referred to as y pieces of transmission order. Here, “y” is a certain natural number.

The processing unit 12 calculates the evaluation values of the respective N pieces of transmission order by using the equation (8) (Operation S102).

The processing unit 12 determines whether the number of times of calculation processing in Operation S102 exceeds an upper limit value (Operation S103). Such an upper limit value is input by the user in advance and stored in “STEP” illustrated in FIG. 8.

In Operation S103, when the value of “j” is the value of “STEP” or less (Operation S103: NO), “1” is added to the value of “j” (Operation S104).

After that, the processing unit 12 generates next N pieces of transmission order (Operation S105). In such a case, first, the processing unit 12 selects a transmission order in the group, in which an evaluation value is a minimum value in Operation S102 or selects a single piece of transmission order in accordance with the evaluation values that have been calculated in Operation S102. The processing in the latter case is described. Hereinafter, such processing is referred to as “selection”.

Here, “selection” is processing to select a single piece of transmission order from the N pieces of transmission order in accordance with a certain rule. As such a rule, for example, there is the following known “roulette selection”. In such roulette selection, a single piece of transmission order is selected as described below. First, the processing unit 12 divides a reciprocal of each of the evaluation values of the N pieces of transmission order by a total value of the reciprocals of the evaluation values. The processing unit 12 probabilistically selects a single piece of transmission order in accordance with the values that have been obtained by such division. Such processing is described below in detail. It is assumed that three pieces of transmission order are used here, and evaluation values of the three pieces of transmission order are respectively 10, 7, and 11. Reciprocals of the evaluation values are respectively 1/10, 1/7, and 1/11. A total value of the reciprocals of the evaluation values is set as “a” (a=1/10+1/7+1/11). Values obtained by dividing the reciprocals of the three evaluation values by “a” are respectively {(1/10)/a}, {(1/7)/a}, and {(1/11)/a}. These values are used for probabilities to select one of the three pieces of transmission order. For example, a probability in which a transmission order of the group, the evaluation value of which is 10, is selected is {(1/10)/a}. The processing to select the transmission order of the group in accordance with the certain rule as described above is “selection”.

In Operation S105, the processing unit 12 causes a transmission order of the group, in which the evaluation value that has been calculated in Operation S102 is minimum value, or a single piece of transmission order that has been selected in accordance with the evaluation values that have been calculated in Operation S102 by the above-described processing of “selection,” to be included in newly-generated N pieces of transmission order in order to use the processing result of Operation S102. In the embodiment, the processing unit 12 causes a transmission order of the group, in which the evaluation value is a minimum value, or a single piece of transmission order that has been selected by the above-described processing of “selection” to be included in the N pieces of transmission order newly generated in Operation S105, but the embodiment is not limited to such an example. For example, the processing unit 12 causes a transmission order of the group, in which the evaluation value is a threshold value or less, to be included in the new N pieces of transmission order instead of the transmission order of the group, in which the evaluation value is a minimum value. In addition, the processing unit 12 selects two or more pieces of transmission order by the processing of “selection” and may cause the selected two or more pieces of transmission order to be included in the new N pieces of transmission order.

Even in Operation S105, the processing unit 12 generates N pieces of transmission order such that the N pieces of transmission order satisfy conditions (1) and (2).

The processing unit 12 calculates evaluation values of the respective N pieces of transmission order that have been generated in Operation S105 in accordance with the equation (8) (Operation S102).

In Operation S103, when the value of “j” becomes larger than the value of “STEP” (Operation S103: YES), the processing unit 12 determines a transmission order of the group, in which the evaluation value is a minimum value in Operation S102, to be a solution (Operation S106).

Here, instead of the processing of Operation S103, for example, the following determination may be performed. The processing unit 12 calculates a change amount in each of the evaluation values of the N pieces of transmission order that have been obtained in Operation S102 compared with the evaluation value that has been obtained in the previous processing of Operation S102, and determines whether the change is sufficiently small or the change has become small. In this case, when the processing unit 12 determines that the change is sufficiently small or the change has become small, the processing unit 12 executes the processing of Operation S106.

The processing unit 12 notifies another communication device 1 in the group of the determined transmission order of the group through the communication unit 11 in order that each of the communication devices 1 in the group transmits a partial key in accordance with the transmission order of the group, which has been determined to be a solution in Operation S106. Each of the communication devices 1 in the group transmits a partial key through the communication unit 11 of the communication device 1 in accordance with the transmission order of the group.

The processing unit 12 may execute processing such as “crossover” or “mutation” that is a method of the known genetic algorithm, in the generation processing of N pieces of transmission order in Operations S100 and S105. The pieces of processing of the crossover and the mutation are described later. It is assumed that the processing unit 12 according to the embodiment executes the processing of the crossover or the mutation in Operation S105. In the generation of the N pieces of transmission order in Operation S105, it is assumed that the processing unit 12 probabilistically executes processing such as the above-described selection, crossover, or mutation. Probabilities of execution of the pieces of processing of the selection, the crossover, and the mutation may be set arbitrarily, but may be respectively set, for example, as 19%, 80%, and 1%, and the processing unit 12 may generate N pieces of transmission order in accordance with the probabilities. When N pieces of transmission order are generated without the processing of “selection” in Operation S105, the processing unit 12 causes one or more pieces of transmission order of the group, in each of which the evaluation value that has been calculated in Operation S102 is a minimum value, to be included in the N pieces of transmission order.

The crossover used in the embodiment is described below. Here, the crossover is processing to select two pieces of transmission order from among the N pieces of transmission order, in each of which the evaluation value has been calculated in Operation S102 before Operation S105, and replace parts of the respective two pieces of transmission order with each other to generate new two pieces of transmission order in the Operation S105. The pieces of transmission order of the group in the embodiment correspond to a gene in the genetic algorithm. In addition, the pieces of transmission order of the group, in each of which the evaluation value is obtained in Operation S102 in the embodiment, correspond to a current generation gene in the genetic algorithm. In addition, the pieces of transmission order of the group, which are generated in Operation S105 after Operation S102, correspond to the next generation gene in the genetic algorithm. In addition, “j” and “STEP” in the embodiment respectively correspond to the number of generations and a threshold value corresponding to the number of generations.

First, in Operation S105, the processing unit 12 selects two pieces of transmission order from among the N pieces of transmission order, in each of which the evaluation value has been calculated in Operation S102. Next, the processing unit 12 determines which of communication devices 1 the crossover is to be applied to, in the two pieces of transmission order. Such determination may be performed randomly. After that, the processing unit 12 determines an area on which the crossover is performed in transmission order of the communication device 1, which is the application target of the crossover. Hereinafter, the area on which the crossover is performed in the transmission order of the communication device 1 is referred to as a crossover area. The crossover area is a range from the top to the z-th number in the transmission order of the communication device 1. Here, “z” is a natural number that is 1 or more or n−2 or less. In addition, “n” is the total number of the communication devices 1 in the group. The reason why “z” is a natural number is 1 to n−2 is described later.

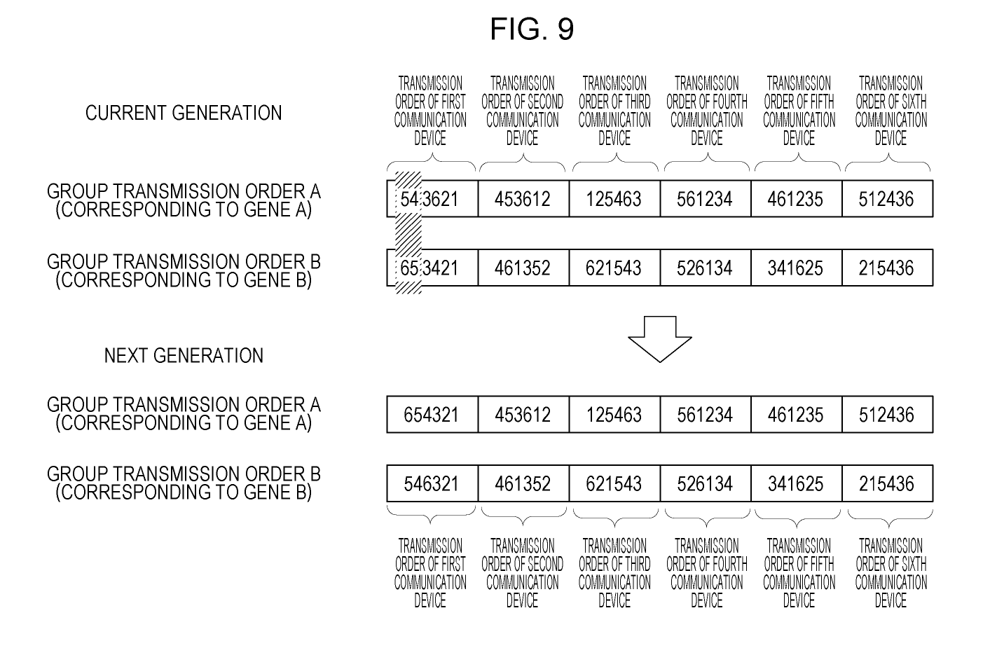

FIG. 9 is a diagram illustrating an example of the crossover in the embodiment. “Group transmission order A” and “group transmission order B” in the upper part of FIG. 9 respectively correspond to the current generations “gene A” and “gene B”. In addition, “group transmission order A” and “group transmission order B” in the lower part of FIG. 9 respectively correspond to the next generations “gene A” and “gene B”. The pieces of transmission order of the group are obtained by combining pieces of transmission order of the first, second, third, fourth, fifth, and sixth communication devices 1 in this order.

The crossover executed by the processing unit 12 is described below further in detail below with reference to FIG. 9. In Operation S105 of the flow described above with reference to FIG. 8, the processing unit 12 selects two pieces of transmission order that are targets of the crossover from the N pieces of transmission order in each of which the evaluation value has been calculated in Operation S102. Here, it is assumed that the two pieces of transmission order that have been selected by the processing unit 12 are “group transmission order A” and “group transmission order B”. Such two pieces of transmission order correspond to the current generation genes. In the following description, the group transmission order corresponding to the current generation gene is also referred to as a current generation gene. Similarly, the group transmission order corresponding to the next generation gene is also referred to as the next generation gene.

After that, the processing unit 12 selects the transmission order of the first communication device 1 from among the current generation genes. In addition, the processing unit 12 sets the crossover area at “z=2”. Here, a sequence of the crossover area in the transmission order of the first communication device 1 in the current generation gene A is “54”. In addition, a sequence of the crossover area in the transmission order of the first communication device 1 in the current generation gene B is “65”. The processing unit 12 replaces the sequences with each other. That is, the processing unit 12 copies the sequence “65” of the crossover area in the transmission order of the first communication device 1 of the current generation gene B to the storage area of the sequence of the crossover area in the transmission order of the first communication device 1 of the next generation gene A. In addition, the processing unit 12 copies the sequence “54” of the crossover area in the transmission order of the first communication device 1 of the current generation gene A to the storage area of the sequence of the crossover area in the transmission order of the first communication device 1 of the next generation gene B.

The processing unit 12 stores numeric values other than 5 and 6 that are stored as the first and second numeric values, in the storage area of the third and later numeric values in the transmission order of the first communication device 1 of the next generation gene A, that is, an area in which a sequence other than the crossover area in the transmission order of the first communication device 1 of the next generation gene A is stored. The order of such numeric values is based on the sequence of the third and later numeric values in the transmission order of the first communication device 1 of the current generation gene A. Here, numeric values stored as the third and later numeric values in the transmission order of the first communication device 1 of the next generation gene A are 1, 2, 3, and 4, but these numeric values are arranged in order of 4, 3, 2, and 1 in the current generation gene A. The processing unit 12 sets the transmission order of the first communication device 1 of the next generation gene A as “654321”, in accordance with the order of the current generation gene A. The same processing is also applied to the next generation gene B. The processing to generate the next generation gene from the current generation gene as described above is the crossover in the embodiment.

Here, the reason why “z” is a natural number that is 1 or more, or n−2 or less is explained. The last number of the transmission order of the communication device 1 indicates a communication device 1 that generates a common key, and is not changed. Therefore, even when the crossover has been performed on two pieces of transmission order of the crossover area in which “z=n” or “n−1” is satisfied, there is no change in such a combination of the two pieces of transmission order. The next generation gene to be generated in the crossover processing in Operation S105 is different from the current generation gene, and therefore, in the embodiment, it is assumed that “z” is a natural number that is 1 or more or n−2 or less. In the embodiment, “n” is 3 or more. This is why “n” is the total number of the communication devices 1 in the group, but the transmission order may not be determined when “n” is 2 or less.

The processing of “mutation” is described below. Here, it is assumed that the processing of “mutation” is “exchange” in the genetic algorithm. The processing unit 12 selects one of the N current generation genes. In addition, in such a gene, the processing unit 12 selects transmission order of a single communication device 1. The processing unit 12 selects two numeric values from numeric values other than the last number in the transmission order of the communication device 1, and replaces the two numeric values with each other.

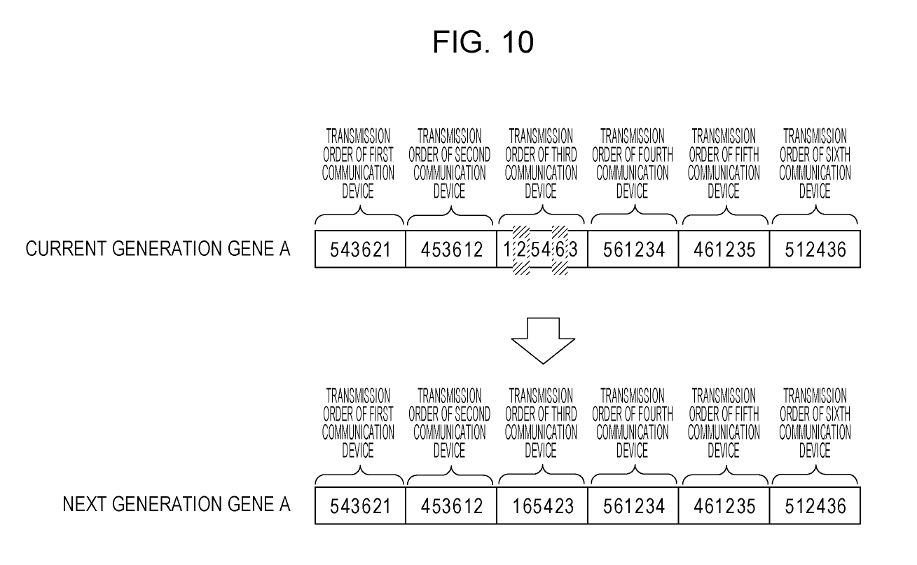

FIG. 10 is a diagram illustrating an example of the mutation (exchange) in the embodiment. A specific example of the mutation is described below with reference to FIG. 10. The processing unit 12 selects a gene A from among N current generation genes. In addition, the processing unit 12 selects a transmission order of the third communication device in the current generation gene A. The processing unit 12 further select two numeric values in the transmission order of the third communication device. In such an example, it is assumed that the processing unit 12 selects the two numeric values randomly. However, the embodiment is not limited to such an example. The processing unit 12 selects the second numeric value “2” and the fifth numeric value “6” in the above-described transmission order of the third communication device and sets the gene in which such numeric values have been replaced with each other in the current generation gene A as the next generation gene A.

The processing unit 12 may perform inversion, stirring, translocation, or the like that is a known method in “mutation” of the genetic algorithm as a method of “mutation” in Operation S105 instead of the above-described “exchange”.

In Operation S105, the processing unit 12 repeats the above-described “selection”, “crossover”, and “mutation” in accordance with the probabilities that have been determined by the user in advance, and ends the generation processing of the next generation gene when the number of generated genes reaches “N” which has been defined.

In the case of “selection”, one of the current generation genes is included in the N next generation genes, but the processing such as “crossover” or “mutation” may not be executed for such a current generation gene. In addition, when the probability of execution processing of “selection” is set at 0%, the processing unit 12 causes the current generation gene in which the evaluation value that has been calculated in Operation S102 is a minimum value to be included in the N next generation genes in order to use the result in Operation S102.

The processing unit 12 repeats the generation processing of the next generation gene until an end condition in which the number of generated genes is N is satisfied.

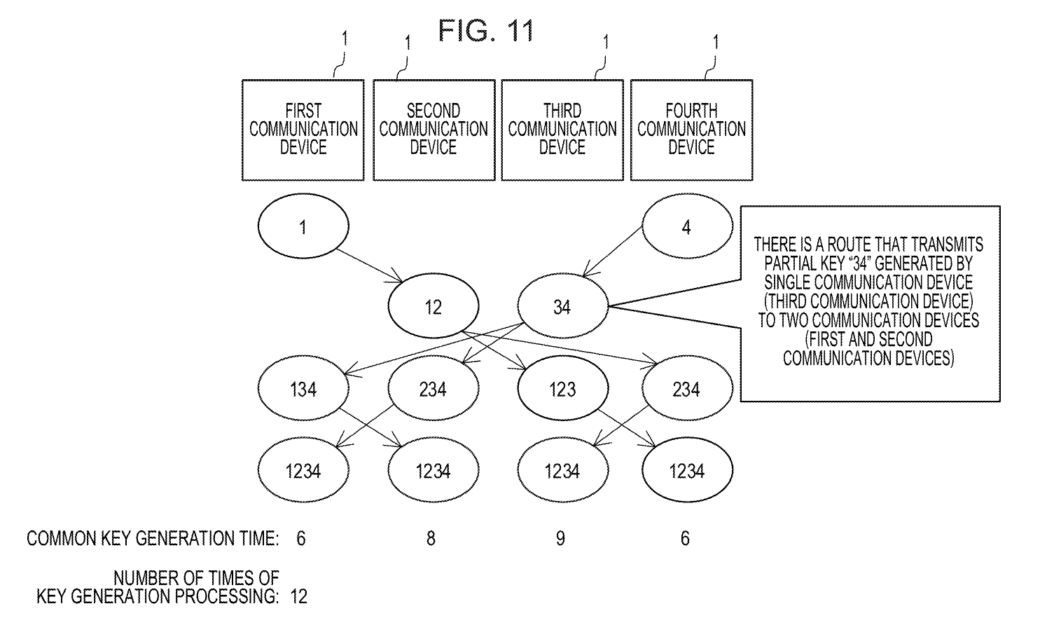

FIG. 11 is a diagram illustrating an example of a transmission order that has been determined by the communication device 1 according to the embodiment. In FIG. 11, it is assumed that a transmission time in a transmission path that connects a certain communication device 1 and another communication device 1 is similar to that of FIG. 4.

The transmission order that has been determined by the communication device 1 is described below in detail with reference to FIG. 11. In FIG. 11, for example, a partial key “4” is generated in the fourth communication device 1. Such a partial key is transmitted to the third communication device, and the third communication device generates a partial key “34” from the received partial key “4” and a private key of the third communication device. The third communication device transmits the generated partial key “34” to the first and second communication devices 1. A transmission route through which a partial key is transmitted until a common key “1234” is generated from the partial key “4” is branched into a transmission route to the first communication device 1 and a transmission route to the second communication device 1 from the third communication device. The transmission routes branched as described above, that is, transmission routes through which the same partial key is transmitted from a single communication device 1 to two or more communication devices 1 are not seen in the example in the related art illustrated in FIG. 5. As descried above, instead of solving of the traveling salesman problem, when the communication device according to the embodiment 1 optimizes a transmission order such that the evaluation index becomes a minimum value as described above, the communication device 1 may select branched transmission routes. In FIG. 11, the partial key “34” that has been generated by the third communication device is used to generate partial keys (“134” and “234”) by respective two communication devices (first and the second communication devices) 1 instead of a single communication device 1.

In addition, as illustrated in FIG. 5, in the transmission order of partial keys in the related art, each of the communication devices in the group generates a partial key by using a private key of the communication device first. However, in the embodiment illustrated in FIG. 11, not all of the communication devices 1 in the group may generate partial keys by using the private keys of the respective communication devices 1 first.

Therefore, in the embodiment, it may be assumed that the number of times of key generation processing by the communication devices 1 in the group is the number of times of key generation processing in the related art or less. In the example illustrated in FIG. 11, the number of times of key generation processing in the group becomes 12 which is the number of ellipses in which numeric values are respectively written, and is also smaller than 16 which is the number of times of key generation processing illustrated in FIG. 5.

A common key generation time of each of the communication devices 1 in the transmission order illustrated in FIG. 11 is described below. As described above, a common key generation time Tₘ of the m-th communication device 1 is a total of transmission times of partial keys that are sources of a common key generated by the m-th communication device. As illustrated in FIG. 11, until a time in which the common key “1234” is generated by the first communication device 1, partial keys are transmitted in accordance with the transmission order “4→3→2→1”. Here, T₁ becomes 6 in accordance with the transmission times of the transmission paths in FIG. 4 similar to the above-described case. Similarly, “T₂=3+4+1=8”, “T₃=1+5+3=9”, and “T₄=1+2+3=6” are obtained. In such a case, the worst value becomes “worst (T₁, T₂, T₃, T₄)=9”.

In addition, a worst value when the partial key is transmitted in accordance with the transmission order illustrated in FIG. 5 is described below. In this case, a transmission time of a partial key between certain two communication devices is also illustrated in FIG. 4. In addition, common key generation times of the communication devices are respectively “T₁=2+3+6=11”, “T₂=3+6+1=10”, “T₃=6+1+2=9”, and “T₄=1+2+3=6”. In such a case, the worst value is 11. As compared with such a worst value, the worst value in the embodiment is small. As a result, in the communication device 1 according to the embodiment, a reduction in the common key generation time is achieved. Specifically, in the embodiment, a time until preparation for common key generation is ready in each of the communication devices 1 after a partial key has been transmitted through a transmission route first is shorter as compared with the related art.

In the embodiment, operation and the like of communication devices 1 in a single group are described above. However, in a case in which one or more communication devices 1 exist across two or more groups (it is assumed that certain two groups from among the two or more groups are groups A and B), when a partial key generated in the group A is also used in the group B, the number of times of key generation processing may be reduced. Therefore, a communication device 1 (or a higher-level device) in the group A (or the group B) may determine, for example, a transmission order of the group A (or the group B) as described below. The communication device 1 (or the higher-level device) subgroups one or more communication devices 1 included in the groups A and B. In addition, the communication device 1 (or the higher-level device) sets a transmission order of at least a certain single communication device 1 in the group A (or the group B) by using a certain communication device 1 in the sub-group as a starting point, in which the communication devices 1 in the sub-group have serial numbers. As a result, in a transmission route corresponding to the transmission order, a partial key using private keys of all communication devices 1 in the sub-group not using a private key of a communication device 1 outside the sub-group is generated by the communication device 1 that is the last communication device in the sub-group. In the groups A and B, such a partial key is delivered to the communication device 1 outside the sub-group. As a result, the number of times of generation processing of partial keys by the communication devices 1 in the sub-group may be reduced. Such determination of transmission order of the group may be performed by a known permutation calculation or the like, instead of the above-described processing.

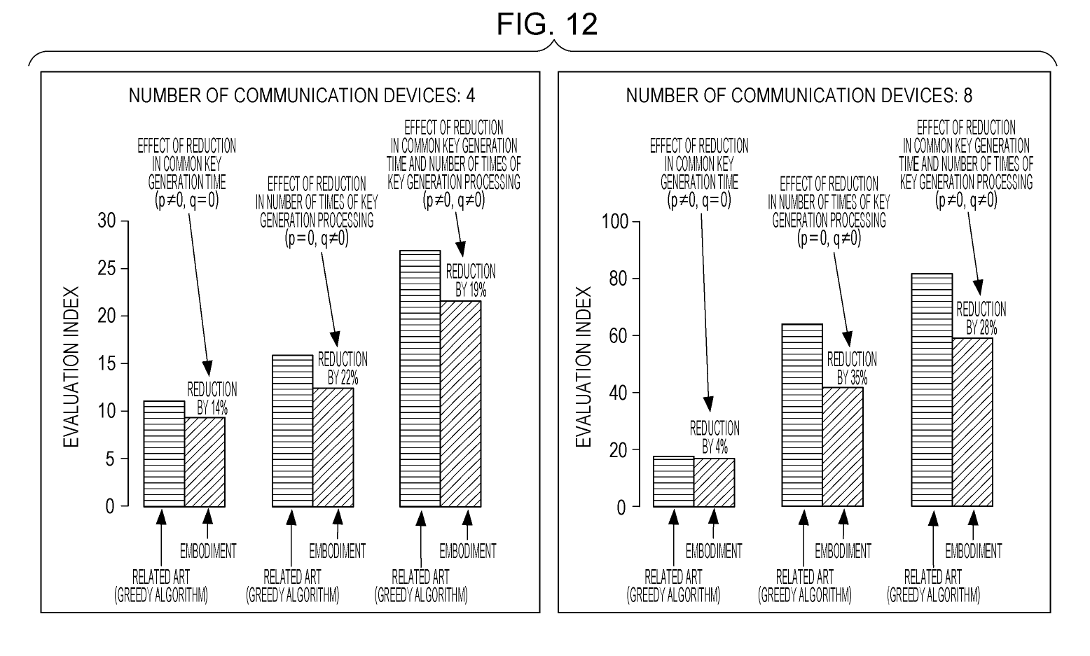

FIG. 12 is a diagram illustrating a comparative example of an effect by the communication method according to the embodiment and an effect by the communication method in the related art. A comparative example of effects in a case in which the number of communication devices 1 in the group is four and a comparative example of effects in a case in which the number of communication devices 1 in the group is eight are respectively illustrated in the left graph and the right graph of FIG. 12. Here, it is assumed that the transmission order of partial keys in the related art is obtained, for example, by solving the traveling salesman problem through the greedy algorithm. In addition, here, in the comparison of the effects, it is assumed that the evaluation index illustrated in the above-described equation (8) is used. This is why a time or the like until generation of a partial key and a common key is completed after each of the communication devices 1 has received a partial key may be changed as appropriate, and the above-described evaluation index may be used as an index used to estimate an actual time taken to generate a common key.

In FIG. 12, a bar chart hatched by horizontal lines and a bar chart hatched by oblique lines respectively indicate an evaluation value when the communication method of partial keys in the related art is used and an evaluation value when the communication method of partial keys in the embodiment is used. In addition, on the left side of each of the graphs of “number of communication devices: 4” and “number of communication devices: 8” illustrated in FIG. 12, a magnitude relation between evaluation values in the related art and the embodiment when the weighting factor q is set at 0 is illustrated. In addition, similarly, in the middle of each of the graphs, a magnitude relation between evaluation values in the related art and the embodiment when the weighting factor p is set at 0 is illustrated, and on the right side of each of the graphs, a magnitude relation between evaluation values in the related art and the embodiment when both of the weighting factors p and q are respectively set at values other than 0 is illustrated. Here, the evaluation index when “weighting factor q=0” is satisfied corresponds to a common key generation time, and an evaluation index when “weighting factor p=0” is satisfied corresponds to the number of times of key generation processing.

Here, a difference between the effects in the related art and the embodiment when the number of communication devices 1 in the group is eight is described. As illustrated in FIG. 12, the common key generation time in the embodiment is reduced by 4% as compared with the related art. Similarly, the number of times of key generation processing in the embodiment is reduced by 35% as compared with the related art. In addition, when both of the common key generation time and the number of times of key generation processing are considered as evaluation indexes, the evaluation value in the embodiment is reduced by 28% as compared with the related art.

A similar result is applied to the case in which the number of communication devices 1 in the group is 4. As compared with the communication method in the related art, in the communication method according to the embodiment, generation processing of a common key may be performed by the smaller number of times as the number of communication devices 1 in the group increases. Therefore, as compared with the communication method in the related art, in the communication method according to the embodiment, a smaller evaluation value may be obtained as the number of communication devices 1 in the group increases.

In the communication device and the communication method according to the embodiment, in two or more communication devices 1 that perform encryption communication with each other by using a common key, a reduction in a common key generation time and a reduction in a processing load of key generation may be achieved.

In the technology discussed herein, various embodiments and modification may be made without departing from the broader spirit and scope of the technology discussed herein. In addition, the above-described embodiments are only for explaining the technology discussed herein, and do not limit the scope of the technology discussed herein. Various modifications which are made within the scope of the claims and within the meaning of the technology discussed herein equivalent thereto are also considered to be within the scope of the technology discussed herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a memory; and
a processor coupled to the memory and the processor configured to:
determine a transmission order such that at least one of a maximum value of a common key generation time from among two or more communication devices and a number of times of key generation processing by the two or more communication devices becomes a minimum value;
instruct another communication device from among the two or more communication devices to transmit a partial key in accordance with the transmission order determined; and
transmit a partial key generated, in accordance with the determined transmission order.

2. The communication device according to claim 1,
wherein the processor is further configured to:
determine the transmission order such that at least one of the maximum value of the common key generation time and the number of times of key generation processing becomes a minimum value.

3. The communication device according to claim 1,
wherein the processor is further configured to:
determine the transmission order such that a sum of the maximum value of the common key generation time and the number of times of key generation processing becomes a minimum value.

4. The communication device according to claim 1,
wherein the processor is further configured to:
determine the transmission order such that a sum of the maximum value of the common key generation time and the number of times of key generation processing becomes a minimum value.

5. The communication device according to claim 1,
wherein the processor is further configured to:
use a genetic algorithm when the transmission order is determined.

6. The communication device according to claim 1,
wherein the processor is further configured to:
determine the transmission order by using at least one of common key generation times and the number of times of key generation processing for all respective pieces of order that are candidates of the transmission order.

7. The communication device according to claim 1,
wherein the processor is further configured to:
when two or more groups share one or more communication devices,
determine the transmission order such that partial keys generated from private keys of the one or more communication devices are transmitted to be shared between the two or more groups for generation of a common key in each of the two or more groups.

8. A communication method comprising:
determining a transmission order such that at least one of a maximum value of a common key generation time from among two or more communication devices and a number of times of key generation processing by the two or more communication devices becomes a minimum value;
instructing another communication device from among the two or more communication devices to transmit a partial key in accordance with the transmission order determined; and
transmitting a partial key generated, in accordance with the determined transmission order, by a processor.

9. A communication method comprising:
generating a first partial key in a first communication device;
transmitting the first partial key from the first communication device to a second communication device;
generating, by the second communication device, a second partial key, using a private key of the second communication device and that includes the first partial key;
transmitting the second partial key from the second communication device to a third communication device and to a fourth communication device;
generating, by the third communication device, a third partial key that includes the second partial key; and
generating, by the fourth communication device, a fourth partial key that includes the second partial key.

10. The communication method of claim 9, wherein the third partial key includes a key of the third communication device.

11. The communication method of claim 9, wherein the fourth partial key includes a key of the fourth communication device.
